(19) United States
(12) Patent Application Publication
(10) Pub. No.: US 2022/0063438 A1
(43) Pub. Date: Mar. 3, 2022

(54) ELECTRIC VEHICLE CHARGING DEVICE WITH INFORMATION OUTPUT UNIT USING LIGHT

(71) Applicant: IGEN Co., LTD, Gwangju (KR)

(72) Inventors: Gun Young CHOI, Gwangju (KR); Hyo Jeong KANG, Gwangju (KR)

(73) Assignee: IGEN Co., LTD, Gwangju (KR)

(21) Appl. No.: 17/117,058

(22) Filed: Dec. 9, 2020

(30) Foreign Application Priority Data
Aug. 27, 2020 (KR) 10-2020-0108489

(51) Int. Cl. B60L 53/66; H02J 7/00; G02B 27/00; G09F 13/00; B08B 3/02

(52) U.S. Cl. CPC B60L 53/66; H02J 7/0047; G02B 1/11; G09F 13/00; B08B 3/02; G02B 27/0006

(57) ABSTRACT

The present invention relates to an electric vehicle charging device with an information output unit using light, and the electric vehicle charging device includes a charging unit installed in a parking space in which a charging target electric vehicle is parked to charge the electric vehicle, a gobo lighting unit provided in the parking space to project an information image onto a floor surface of the parking space, an information receiving unit configured to receive information about charging of the electric vehicle from the charging unit when the corresponding electric vehicle is charged, and an image providing unit configured to provide the information image to the gobo lighting unit and generate the information image to include the information about charging of the electric vehicle received from the information receiving unit.

### CROSS-REFERENCE TO RELATED APPLICATIONS

This application claims priority to and the benefit of Korean Patent Application No. 10-2020-0108489, filed on Aug. 27, 2020, the disclosure of which is incorporated herein by reference in its entirety.

### BACKGROUND

### 1. Field of the Invention

The present invention relates to an electric vehicle charging device with an information output unit using light, and more specifically, to an electric vehicle charging device with an information output unit using light which projects notification information about a charging state onto a floor surface of a parking space so that a driver who has exited an electric vehicle to charge the electric vehicle easily recognizes the charging state of the vehicle.

### 2. Discussion of Related Art

Electric vehicles are eco-friendly vehicles which are moved by only electricity as power and in which high voltage batteries supply electric energy to electric motors to generate driving power.

Since the electric vehicle does not use fossil fuel, there are advantages in that exhaust gas such as carbon dioxide (CO₂) or nitrogen oxide (NOₓ) is barely generated, noise is not generated, and the like.

In addition, in order to prevent increasing environmental pollution and a shortage of resources, the electric vehicles are being commercialized, and accordingly, electric vehicle charging stations need to be installed. The conventional electric vehicle charging device has disadvantages of cumbersomeness and low visibility because a driver who charges the electric vehicle should check information displayed on a display panel provided on a main body of the charging device to recognize a charging state of the vehicle.

### RELATED ART

### Patent Document

Registered Patent Publication No. 10-1864197: ELECTRICAL VEHICLE CHARGING SYSTEM AND METHOD FOR CONTROLLING THEREOF

### SUMMARY OF THE INVENTION

The present invention is directed to providing an electric vehicle charging device with an information output unit using light capable of projecting a notification image including information about a charging state of a vehicle onto a floor surface of a parking space in which the corresponding electric vehicle is parked.

According to an aspect of the present invention, there is provided an electric vehicle charging device with an information output unit using light, the electric vehicle charging device including a charging unit installed in a parking space in which a charging target electric vehicle is parked to charge the electric vehicle, a gobo lighting unit provided in the parking space to project an information image onto a floor surface of the parking space, an information receiving unit configured to receive information about charging of the electric vehicle from the charging unit when the corresponding electric vehicle is charged, and an image providing unit configured to provide the information image to the gobo lighting unit and generate the information image to include the information about charging of the electric vehicle received from the information receiving unit.

When the charging unit does not charge the electric vehicle, the image providing unit may generate the information image to include advertising information stored in advance.

Meanwhile, the electric vehicle charging device may further include a position detection unit provided in the parking space to detect a position of a driver who exits the electric vehicle, wherein the gobo lighting unit may project the information image onto the floor surface of the parking space at a position close to the driver on the basis of detected information provided from the position detection unit.

In addition, the electric vehicle charging device may also further include an anti-reflective coating layer formed on the floor surface, onto which the information image is projected, of the parking space and configured to suppress reflection of incident light to improve visibility of the information image projected from the gobo lighting unit.

In addition, the electric vehicle charging device may further include an approach detection unit configured to detect a person positioned within a predetermined range from the parking space or the charging unit, wherein, in a case in which the approach detection unit detects the person within the predetermined range from the parking space or the charging unit, the gobo lighting unit may also project the information image onto the floor surface of the parking space. In addition, the electric vehicle charging device may also further include a screen member provided on the floor surface of the parking space to allow the gobo lighting unit to project the information image onto the screen member and a cleaning unit provided on the screen member to remove a foreign material fixedly attached onto the screen member.

The cleaning unit may include at least one spray nozzle installed on an edge of one side of the screen member to spray cleaning water onto an upper surface of the screen member and a cleaning water supply unit configured to supply the cleaning water to the spray nozzle to allow the spray nozzle to spray the cleaning water.

An edge of the other side of the screen member may be rotatably supported by the floor surface of the parking space, and the cleaning unit may further include an elevation member configured to move the edge of the one side of the screen member in an upward direction to allow the edge of the one side to be spaced apart from the floor surface of the parking space by a predetermined distance so that the screen member is set to be inclined at a predetermined angle when the spray nozzle sprays the cleaning water and a warpage generation unit of which both end portions are installed on a lower surface of the screen member at positions spaced apart from each other in a direction intersecting a direction in which the spray nozzle sprays the cleaning water, and of which a length between both of the end portions is periodically increased and decreased to generate a warpage of the screen member when the spray nozzle sprays the cleaning water.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating an electric vehicle charging device with an information output unit using light according to an embodiment of the present invention;

FIG. 2 is a block diagram illustrating the electric vehicle charging device with an information output unit using light of FIG. 1;

FIG. 3 is a block diagram illustrating an electric vehicle charging device with an information output unit using light according to another embodiment of the present invention;

FIG. 4 is a side view illustrating an electric vehicle charging device with an information output unit using light according to still another embodiment of the present invention;

FIG. 5 is a block diagram illustrating an electric vehicle charging device with an information output unit using light according to yet another embodiment of the present invention;

FIG. 6 is a cross-sectional view illustrating an electric vehicle charging device with an information output unit using light according to yet another embodiment of the present invention; and

FIG. 7 is a perspective view illustrating an electric vehicle charging device with an information output unit using light according to another embodiment of the present invention.

### DETAILED DESCRIPTION OF EXEMPLARY EMBODIMENTS

Hereinafter, an electric vehicle charging device with an information output unit using light according to embodiments of the present invention will be described in detail with reference to the accompanying drawings. Since the present invention allows for various changes and numerous embodiments, specific embodiments will be illustrated in the drawings and described in detail in the written description. However, this is not intended to limit the present invention to specific embodiments, and it is to be appreciated that all changes, equivalents, and substitutes that do not depart from the spirit and technical scope of the present invention are encompassed in the present invention. Like numbers refer to like elements throughout the description of the drawings. In the accompanying drawings, sizes of structures may be greater than those of actual structures for clarity of the present invention.

Although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present invention.

The terminology used herein is for the purpose of describing particular embodiments only and is not intended to be limiting to the invention. As used herein, the singular forms “a,” “an,” and “the” are intended to include the plural forms as well, unless the context clearly indicates otherwise. It will be further understood that the terms “comprises,” “comprising,” “includes,” and “including,” when used herein, specify the presence of stated features, integers, steps, operations, elements, components, and/or groups thereof but do not preclude the presence or addition of one or more other features, integers, steps, operations, elements, components, and/or groups thereof.

Unless otherwise defined, all terms (including technical and scientific terms) used herein are to be interpreted as being customary to those skilled in the art. It should be further understood that terms in common usage should also be interpreted as being customary in the relevant art and not in an idealized or overly formal sense unless expressly so defined herein.

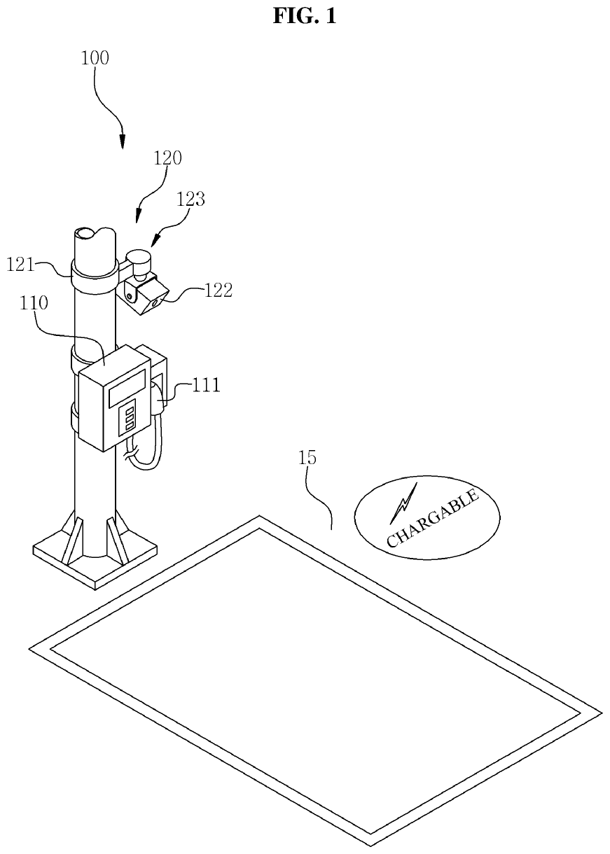

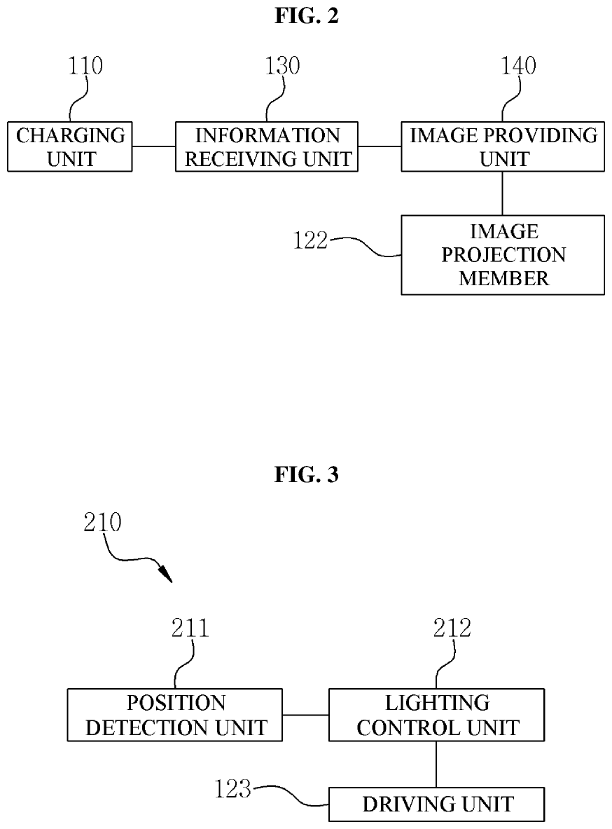

In FIGS. 1 and 2, an electric vehicle charging device 100 with an information output unit using light according to an embodiment of the present invention is illustrated.

Referring to the drawings, the electric vehicle charging device 100 with an information output unit using light includes a charging unit 110 installed in a parking space 15 in which a charging target electric vehicle is parked to be charged, a gobo lighting unit 120 provided in the parking space 15 to project an information image onto a floor surface of the parking space 15, an information receiving unit 130 configured to receive information about charging of the electric vehicle from the charging unit 110 when the corresponding electric vehicle is charged, and an image providing unit 140 configured to provide the information image to the gobo lighting unit 120.

The charging unit 110 is installed on an electric pole and configured to charge the electric vehicle. In this case, as an existing electric pole is used for the charging unit 110, land purchase may not be needed so that an installation cost may be reduced. In addition, since the charging unit 110 may be detachably provided on the electric pole, maintenance thereof may be easy in the case of a failure. In addition, since a connector hanger capable of storing a connector 111 is embedded in the charging unit 110, stability may be secured.

Meanwhile, although not illustrated in the drawings, the charging unit 110 includes a power calculation unit configured to calculate an amount of power required for charging the electric vehicle connected to the connector 111, a vehicle information collection unit configured to receive information about a charging rate of a battery of the electric vehicle from the corresponding electric vehicle connected to the connector 111, a payment calculation unit configured to calculate an amount of payment on the basis of power information calculated by the power calculation unit, and a display panel provided to display information, which is collected from the payment calculation unit, the power calculation unit, and the vehicle information collecting unit, for the driver.

In this case, a structure in which the charging unit 110 is installed on the electric pole is illustrated in the drawing, but the present invention is not limited thereto. The charging unit 110 may also be installed on a streetlight pole or a separate pole provided in the parking space 15.

The gobo lighting unit 120 includes a bracket 121 installed around the electric pole, an image projection member 122 provided on the bracket 121 to project an information image onto the floor surface of the parking space 15, and a driving unit 123 installed on the image projection member 122 to rotate the corresponding image projection member 122 in an up-down or left-right direction.

The bracket 121 is installed around the electric pole at a position spaced upward from the charging unit 110. Meanwhile, the bracket 121 is not limited thereto and may also be installed on a wall surface of a structure or streetlight pole close to the parking space 15.

The image projection member 122 is a member supported by the bracket 121 through the driving unit 123 and configured to project the information image onto the floor surface of the parking space 15 and, although not illustrated in the drawings, incudes a projection body including a projection lens in the front thereof and configured to project an image beam through the projection lens, a diode array which is installed in the projection body and in which a plurality of light-emitting diodes or laser diodes for forming pixels are arrayed, a focusing unit configured to focus light emitted from the diode array, and a protector which is provided in the projection body and in which a scan unit including a mirror for scanning light focused by the focusing unit onto the floor surface of the parking space 15 is provided. Meanwhile, the image projection member 122 is not limited thereto, and any image projection unit capable of projecting an information image onto a floor surface of a parking lot may be applied as the image projection member 122.

Although not illustrated in the drawings, the driving unit 123 is rotatably installed on the bracket 121 in the left-right direction and includes a support allowing the image projection member 122 to be rotatable in the up-down direction and a rotation driving member configured to rotate the image projection member 122 in the up-down direction or rotate the support about a frame. The rotation driving member may include a plurality of driving motors installed in a rotary shaft of the image projection member 122 and a rotary shaft of the support.

The information receiving unit 130 is connected to the charging unit 110 to receive information about charging of the electric vehicle from the corresponding charging unit 110. In this case, the information about charging of the electric vehicle includes an amount of power required for charging the connected electric vehicle, a charging rate of the battery of the corresponding electric vehicle, and an amount of payment for charging of the corresponding electric vehicle. The corresponding information receiving unit 130 may be connected to the corresponding charging unit 110 through a wired or wireless communication network.

The image providing unit 140 provides the information image to the gobo lighting unit 120 so that the corresponding gobo lighting unit 120 may project the information image onto the floor surface of the parking space 15. In this case, the image providing unit 140 may generate and provide the information image to include the information about charging of the electric vehicle received from the information receiving unit 130. In this case, the image providing unit 140 may generate the information image in which the information about charging of the corresponding electric vehicle is displayed in a text or graph type.

Meanwhile, the image providing unit 140 further includes a database (not shown) in which advertising information which may be included in the information image is stored. The image providing unit 140 may generate the information image to include the advertising information stored in the database in advance and provide the information to the image projection member 122 when the charging unit 110 does not charge the electric vehicle.

That is, in a case in which the electric vehicle is connected to the charging unit 110 and is being charged, the image providing unit 140 generates the information image to include the information about charging of the electric vehicle provided from the information receiving unit 130, and in a case in which the electric vehicle is not charged, the image providing unit 140 generates the information image to include the advertising information stored in the database and provides the information image to the image projection member 122 of the gobo lighting unit 120. In this case, a manager may store the corresponding advertising information in the database, or the database may be connected to a management server that manages the advertising information and may store the advertising information provided from the corresponding management server.

An operation of the electric vehicle charging device 100 with an information output unit using light according to the present invention will be described in detail below.

First, the driver parks the electric vehicle in the parking space 15 in which the charging unit 110 is provided in order to charge the electrical vehicle. When the electrical vehicle is completely parked in the parking space 15, the driver exits the vehicle, connects the connector 111 of the charging unit 110 to the corresponding electric vehicle, and performs charging on the electric vehicle. In this case, the information receiving unit 130 receives information about charging of the corresponding electric vehicle from the charging unit 110 and provides the information to the image providing unit 140. The image providing unit 140 generates an information image to include the information about charging of the corresponding electric vehicle and provides the information image to the gobo lighting unit 120. The gobo lighting unit 120 projects the information image received from the image providing unit 140 onto the floor surface of the parking space 15.

Since the electric vehicle charging device 100 with an information output unit using light according to the present invention may project a notification image including information about a charging state of the corresponding vehicle onto the floor surface of the parking space 15 in which the electric vehicle is parked, there is an advantage in that visibility of the corresponding notification image is improved so that the driver who has exited the electric vehicle may easily recognize the charging state of the vehicle. In addition, in the present invention, since a driver of an electric vehicle waiting for charging may recognize the charging state of the electric vehicle connected to the corresponding charging unit 110, the driver may move to another charging unit 110 at which a waiting time is relatively short so that the driver may effectively wait therefor.

Meanwhile, in FIG. 3, an electric vehicle charging device 210 with an information output unit using light according to another embodiment of the present invention is illustrated.

Components having functions that are the same as the functions of those illustrated in the above-described drawings will refer to the same numerals.

Referring to the drawings, the electric vehicle charging device 210 with an information output unit using light further includes a position detection unit 211 provided in a parking space 15 to detect a position at which a driver exits an electric vehicle.

Although not illustrated in the drawing, the position detection unit 211 includes a thermal imaging camera installed on a charging unit 110 or an electric pole on which the corresponding charging unit 110 is installed to capture a thermal image of the parking space 15 and an image analysis unit configured to analyze the thermal image provided from the corresponding thermal imaging camera so as to determine a position of the driver in the parking space 15. The image analysis unit determines the driver in the corresponding thermal image and analyzes the position of the determined driver.

Meanwhile, the position detection unit 211 is not limited thereto and may also include an imaging camera installed on the charging unit 110 or electric pole on which the corresponding charging unit 110 is installed to capture an image of the parking space 15 and an image discrimination unit configured to analyze the captured image provided from the corresponding imaging camera to determine a position of the drive in the parking space 15.

Meanwhile, a gobo lighting unit 120 further includes a lighting control unit 212 capable of controlling a driving unit 123 on the basis of detected information, that is, position information, of the driver provided from the position detection unit 211. The lighting control unit 212 controls the driving unit 123 to project an information image onto a floor surface of the parking space 15 at a position close to the driver on the basis of the position information of the driver provided from the position detection unit 211.

Since the electric vehicle charging device 210 with an information output unit using light according to the present invention projects an information image onto a position close to the driver, visibility of the information image for the driver is improved so that the driver may recognize the information image more easily.

Meanwhile, in FIG. 4, an electric vehicle charging device 220 with an information output unit using light according to still another embodiment of the present invention is illustrated.

Referring to the drawing, the electric vehicle charging device 220 with an information output unit using light further includes an anti-reflective coating layer 221 formed on a floor surface of a parking space 15 onto which an information image is projected and configured to suppress incident light from being reflected to improve visibility of the information image projected from a gobo lighting unit 120.

The anti-reflective coating layer 221 may be formed to cover the parking space 15 in which an electric vehicle is parked, and an upper surface thereof may have a dark color such as a black or grey color. In addition, anti-reflective coating may be performed on the anti-reflective coating layer 221 to absorb incident light, or the upper surface of the anti-reflective coating layer 221 may be unevenly machined to irregularly reflect incident light.

Since light incident on the floor surface of the parking space 15 is suppressed from being reflected by the corresponding anti-reflective coating layer 221, there is an advantage in that visibility of an information image projected by the gobo lighting unit 120 is improved so that recognition of the driver about charging information is improved.

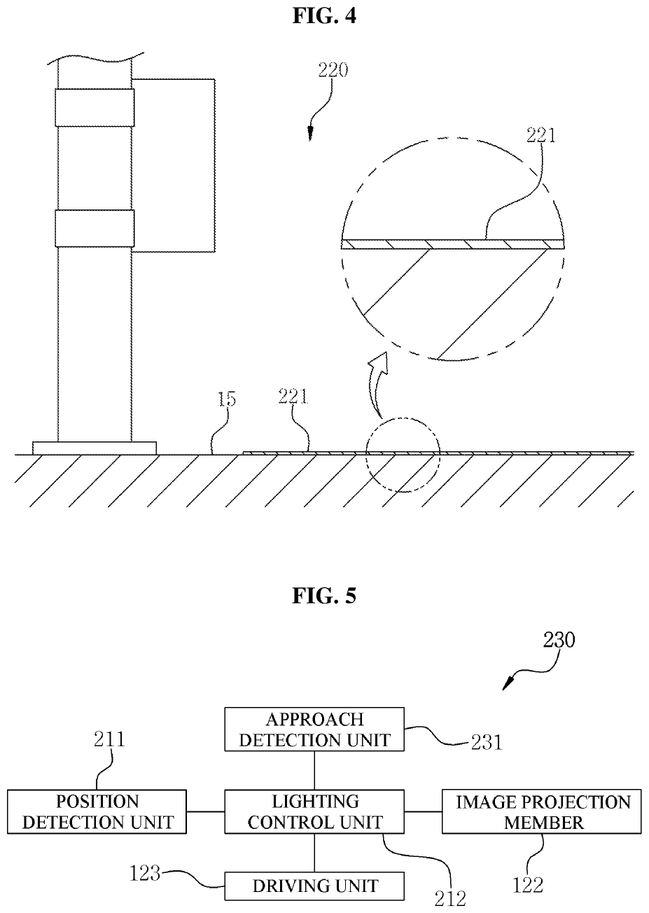

Meanwhile, in FIG. 5, an electric vehicle charging device 230 with an information output unit using light according to another embodiment of the present invention is illustrated.

Referring to the drawing, the electric vehicle charging device 230 with an information output unit using light includes an approach detection unit 231 configured to detect a person positioned within a preset range from a parking space 15 or charging unit 110.

The approach detection unit 231 is installed on the charging unit 110 or electric pole, on which the charging unit 110 is installed, to detect the person positioned within the preset range from the parking space 15 or the charging unit 110. Since the approach detection unit 231 is a detection sensor conventionally and generally used to detect whether a person approaches an installation place, a detailed description thereof will be omitted. In this case, the approach detection unit 231 provides detected information to the lighting control unit 212.

In a case in which the approach detection unit 231 detects a person within the preset range from the parking space 15 or the charging unit 110, the lighting control unit 212 controls an image projection member 122 to project an information image on to a floor surface of the parking space 15.

As described above, since the electric vehicle charging device 230 with an information output unit using light operates the image projection member 122 only when a person approaches, the image projection member 122 is prevented from being unnecessarily operated so that an expense required for maintaining the device may be reduced.

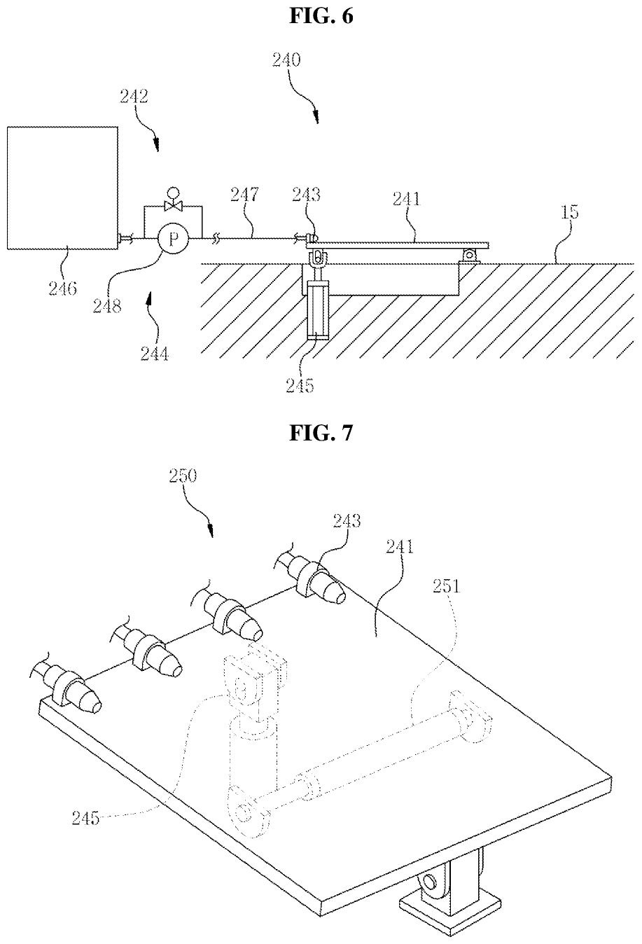

Meanwhile, in FIG. 6, an electric vehicle charging device 240 with an information output unit using light according to another embodiment of the present invention is illustrated.

Referring to the drawing, the electric vehicle charging device 240 with an information output unit using light includes a screen member 241 provided on a floor surface of a parking space 15 to allow an information image to be projected thereon by the gobo lighting unit 120 and a cleaning unit 242 provided on the screen member 241 to remove foreign materials fixedly attached onto the screen member 241.

The screen member 241 is formed in a plate shape having a predetermined thickness, and spray nozzles 243 of the cleaning unit 242, which will be described below, are installed on an edge of one side thereof. In addition, an edge of the other side of the screen member 241 is rotatably installed on the floor surface of the parking space 15 in an up-down direction. In this case, the gobo lighting unit 120 may be set to project an information image onto an upper surface of the screen member 241.

In addition, although not illustrated in the drawing, the upper surface of the screen member 241 may have a dark color such as a black or grey color to improve visibility of the information image.

The cleaning unit 242 includes the plurality of spray nozzles 243 installed on the edge of the one side of the screen member 241 to spray cleaning water onto the upper surface of the screen member 241, a cleaning water supply unit 244 configured to supply the cleaning water to the spray nozzles 243 to allow the spray nozzle 243 to spray the cleaning water, and an elevation member 245 configured to move the edge of the one side of the screen member 241 in an upward direction to allow the edge of the one side to be spaced apart from the floor surface of the parking space 15 by a predetermined distance so that the screen member 241 is set to be inclined at a predetermined angle when the cleaning water is sprayed from the spray nozzle 243.

The plurality of spray nozzles 243 are disposed to be spaced apart from each other along the edge of the one side of the screen member 241, and spray holes are formed in end portions thereof facing a center of the upper surface of the screen member 241 to allow the cleaning water to be sprayed onto the upper surface of the screen member 241. Meanwhile, a structure in which four spray nozzles 243 are installed in the screen member 241 is illustrated in the drawing, but the spray nozzle 243 is not limited thereto, and three or less or five or more screen members 241 may be provided according to a size thereof.

The cleaning water supply unit 244 includes a water tank 246 in which the cleaning water is contained, supply pipes 247 connected to the water tank 246 and the spray nozzles 243, and a supply pump 248 installed in the supply pipes 247 to pump the cleaning water contained in the water tank 246 to the spray nozzles 243.

In the elevation member 245, an upper end is rotatably installed on the edge of the one side of the screen member 241, and a lower end is installed on the floor surface of the parking space 15. An actuator of which a vertical length is increased or decreased by power or a hydraulic pressure applied from the outside to rotate the screen member 241 is applied to the elevation member 245. The elevation member 245 moves the edge of the one side of the screen member 241 in an upward direction by a predetermined distance to obliquely support the corresponding screen member 241 when the cleaning water is sprayed from the spray nozzle 243. Since the screen member 241 is obliquely supported by the elevation member 245, foreign materials fixedly attached to the upper surface of the screen member 241 may be easily separated therefrom by the cleaning water sprayed from the spray nozzle 243.

Meanwhile, the cleaning unit 242 may also further include a cleaning control unit (not shown) for operating the cleaning water supply unit 244 and the elevation member 245. The corresponding cleaning control unit includes an input module allowing a manager to input an operation signal to perform a cleaning operation, when the operation signal is input through the corresponding input module, operates the supply pump 248 of the cleaning water supply unit 244 to allow the spray nozzle 243 to spray the cleaning water, operates the elevation member 245 to obliquely support the screen member 241, and moves the edge of the one side of the screen member 241 in the upward direction with respect to the floor surface of the parking space 15 by a predetermined distance.

After a preset operation time is passed from a time point at which cleaning water spray is started, the cleaning control unit stops the supply pump 248 of the cleaning water supply unit 244 and controls the elevation member 245 to lower the edge of the one side of the screen member 241.

As described above, in the electric vehicle charging device 240 with an information output unit using light, since the cleaning unit 242 is provided to remove foreign materials fixedly attached onto the screen member 241 onto which an information image is projected, there is an advantage in that the distortion of the information image due to the foreign materials is prevented so that visibility of the corresponding information image for a driver is improved.

Meanwhile, in FIG. 7, a cleaning unit 250 according to yet another embodiment of the present invention is illustrated.

Referring to the drawing, the cleaning unit 250 further incudes a warpage generation unit 251 which is installed on a lower surface of a screen member 241 to generate warpages of the screen member 241.

Both end portions of the warpage generation unit 251 are installed on the lower surface of the screen member 241 at positions spaced apart from each other in a direction intersecting a direction in which cleaning water is sprayed from a spray nozzle 243. In this case, an actuator such as a cylinder, which is operated by power or a hydraulic pressure input to periodically increase and decrease a length between both of the end portions thereof so as to generate warpages of the screen member 241 when the cleaning water is sprayed from the spray nozzle 243, is applied to the warpage generation unit 251. Meanwhile, in the drawing, the warpage generation unit 251 is set in a left-right direction, that is, a width direction of the screen member 241 but is not limited thereto and may be set in a diagonal direction of the screen member 241.

Meanwhile, the warpage generation unit 251 may be controlled by a cleaning control unit of a cleaning unit 250. When a supply pump 248 operates, the cleaning control unit may operate the warpage generation unit 251 to periodically elongate or shorten the corresponding warpage generation unit 251. As described above, since the warpage generation unit 251 generates warpages of the screen member 241 when the spray nozzle 243 sprays the cleaning water, there is an advantage of improving foreign material removing efficiency.

In an electric vehicle charging device with an information output unit using light according to the present invention, since a notification image including information about a charging state of a vehicle can be projected onto a floor surface of a parking space in which the corresponding electric vehicle is parked, there is an advantage in that visibility of the corresponding notification image is improved so that a driver who has exited the electric vehicle can recognize the charging state of the vehicle more easily.

The descriptions about the disclosed embodiments are provided for those skilled in the art to use or implement the present invention. Various modifications of the embodiments will be clear to those skilled in the art, and general principles defined in the present specification may be applied to other embodiments without departing from the scope of the present invention. Therefore, the present invention is not limited to the embodiments disclosed in the present specification and should be interpreted within the widest scope consistent with the principles and novel features disclosed in the present specification.

What is claimed is:

1. An electric vehicle charging device with an information output unit using light, the electric vehicle charging device comprising:
a charging unit installed in a parking space in which a charging target electric vehicle is parked to charge the electric vehicle;
a gobo lighting unit provided in the parking space to project an information image onto a floor surface of the parking space;
an information receiving unit configured to receive information about charging of the electric vehicle from the charging unit when the corresponding electric vehicle is charged; and
an image providing unit configured to provide the information image to the gobo lighting unit and generate the information image to include the information about charging of the electric vehicle received from the information receiving unit.

2. The electric vehicle charging device of claim 1, wherein, when the charging unit does not charge the electric vehicle, the image providing unit generates the information image to include advertising information stored in advance.

3. The electric vehicle charging device of claim 1, further comprising a position detection unit provided in the parking space to detect a position of a driver who exits the electric vehicle,
wherein the gobo lighting unit projects the information image onto the floor surface of the parking space at a position close to the driver on the basis of detected information provided from the position detection unit.

4. The electric vehicle charging device of claim 1, further comprising an anti-reflective coating layer formed on the floor surface, onto which the information image is projected, of the parking space and configured to suppress reflection of incident light to improve visibility of the information image projected from the gobo lighting unit.

5. The electric vehicle charging device of claim 1, further comprising an approach detection unit configured to detect a person positioned within a predetermined range from the parking space or the charging unit,
wherein, in a case in which the approach detection unit detects the person within the predetermined range from the parking space or the charging unit, the gobo lighting unit projects the information image onto the floor surface of the parking space.

6. The electric vehicle charging device of claim 1, further comprising:
a screen member provided on the floor surface of the parking space to allow the gobo lighting unit to project the information image onto the screen member; and
a cleaning unit provided on the screen member to remove a foreign material fixedly attached onto the screen member.

7. The electric vehicle charging device of claim 6, wherein the cleaning unit includes:
at least one spray nozzle installed on an edge of one side of the screen member to spray cleaning water onto an upper surface of the screen member; and
a cleaning water supply unit configured to supply the cleaning water to the spray nozzle to allow the spray nozzle to spray the cleaning water.

8. The electric vehicle charging device of claim 7, wherein:
an edge of the other side of the screen member is rotatably supported by the floor surface of the parking space; and
the cleaning unit further includes:
an elevation member configured to move the edge of the one side of the screen member in an upward direction to allow the edge of the one side to be spaced apart from the floor surface of the parking space by a predetermined distance so that the screen member is set to be inclined at a predetermined angle when the spray nozzle sprays the cleaning water; and
a warpage generation unit of which both end portions are installed on a lower surface of the screen member at positions spaced apart from each other in a direction intersecting a direction in which the spray nozzle sprays the cleaning water and of which a length between both of the end portions is periodically increased and decreased to generate a warpage of the screen member when the spray nozzle sprays the cleaning water.
